(19) United States
(12) Patent Application Publication
(10) Pub. No.: US 2026/0064335 A1
(43) Pub. Date: Mar. 5, 2026

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventors: SHODAI YANO, Tokyo (JP); SHUNSUKE MAKI, Tokyo (JP)

(21) Appl. No.: 19/382,104

(22) Filed: Nov. 6, 2025

Related U.S. Application Data
(63) Continuation of application No. PCT/JP2024/016270, filed on Apr. 25, 2024.

(30) Foreign Application Priority Data
May 11, 2023 (JP) 2023-078695

(51) Int. Cl. G06F 3/12

(52) U.S. Cl. CPC G06F 3/1231; G06F 3/1236; G06F 3/1292

(57) ABSTRACT

An information processing apparatus includes: a first acquisition unit that acquires first identification information as a MAC address from a communication apparatus; a second acquisition unit that acquires, based on a fact that the acquired first identification information is a MAC address that is randomized in the communication apparatus by a predetermined function of randomizing a MAC address of the communication apparatus, second identification information as a predetermined kind of identification information different from a MAC address from the communication apparatus that has transmitted the first identification information to the information processing apparatus; and a first execution unit that executes, using the acquired second identification information, processing for communicating with the communication apparatus that has transmitted the first identification information to the information processing apparatus.

### CROSS-REFERENCE TO RELATED APPLICATIONS

This application is a Continuation of International Patent Application No. PCT/JP2024/016270, filed April 25, 2024, which claims the benefit of Japanese Patent Application No. 2023-078695, filed May 11, 2023, both of which are hereby incorporated by reference herein in their entirety.

### BACKGROUND

### Field of the Technology

The present disclosure relates to an information processing apparatus, a method, and a non-transitory computer-readable storage medium storing a program.

### Description of the Related Art

In recent years, a technique of operating, using an information processing apparatus such as a smartphone or a PC, a communication apparatus connectable to the Internet, such as an image forming apparatus or a home appliance, has become popular. To allow a user to select a specific communication apparatus from an information processing apparatus and operate it, the information processing apparatus stores network information such as the IP address and MAC address of the communication apparatus when communicating with the communication apparatus. Then, when performing subsequent connection to the specific communication apparatus in accordance with a user operation, connection to the stored IP address is performed. However, in a case where the IP address of the communication apparatus has been changed by DHCP (Dynamic Host Configuration Protocol), the information processing apparatus cannot discover the IP address, and communication is impossible. In this case, the MAC address of the communication apparatus is acquired by broadcast communication, and is compared with the MAC address stored in the information processing apparatus, thereby specifying the communication apparatus.

On the other hand, since there is a security concern that the MAC address of the communication apparatus is observed by a third party to specify the user, a technique (to be referred to as MAC address randomization hereinafter) of periodically changing the MAC address is introduced to devices such as a smartphone. In a case where the MAC address of the communication apparatus has been randomized, it is impossible to specify the communication apparatus from the information processing apparatus by the above-described method.

According to Japanese Patent Laid-Open No. 2017-525287, the first wireless terminal transmits, to the second wireless terminal, an identifier generated from the stored MAC address of the second wireless terminal. The second wireless terminal verifies the received identifier, and if the identifier is correct, transmits the current MAC address to the first wireless terminal. Then, the first wireless terminal establishes connection to the second wireless terminal by the received MAC address.

Japanese Patent Laid-Open No. 2017-525287 describes communication between two apparatuses of an information processing apparatus and a specific communication apparatus. A mechanism for making it possible to specify, from a plurality of communication apparatuses existing on a network, the communication apparatus with which communication is to be performed even in a case where the identification information of the communication apparatus has been randomized is required.

### SUMMARY

Present disclosure is directed to provide an information processing apparatus that specifies a desired communication apparatus from a plurality of communication apparatuses even in a case where the identification information of the communication apparatus has been randomized, a method, and a non-transitory computer-readable storage medium storing a program.

The disclosure in one aspect provides an information processing apparatus comprising at least one memory and at least one processor which function as: a first acquisition unit configured to acquire first identification information as a MAC address from a communication apparatus; a second acquisition unit configured to acquire, based on a fact that the acquired first identification information is a MAC address that is randomized in the communication apparatus by a predetermined function of randomizing a MAC address of the communication apparatus, second identification information as a predetermined kind of identification information different from a MAC address from the communication apparatus that has transmitted the first identification information to the information processing apparatus; and a first execution unit configured to execute, using the acquired second identification information, processing for communicating with the communication apparatus that has transmitted the first identification information to the information processing apparatus.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing the configuration of a system including an information processing apparatus and a communication apparatus.

FIG. 2 is a view showing a user interface screen.

FIG. 3A is a flowchart illustrating processing executed by the information processing apparatus.

FIG. 3B is a flowchart illustrating the processing executed by the information processing apparatus.

FIG. 4A is a flowchart illustrating processing executed by an information processing apparatus.

FIG. 4B is a flowchart illustrating the processing executed by the information processing apparatus.

FIG. 5 is a sequence chart showing network setup processing.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

### First Embodiment

An information processing apparatus 101 and a communication apparatus 151 included in a communication system according to this embodiment will be described. In this embodiment, a smartphone is exemplified as the information processing apparatus 101 but the present disclosure is not limited to this. For example, as the information processing apparatus 101, various kinds of apparatuses such as a portable terminal, a PC (Personal Computer), a tablet terminal, a PDA (Personal Digital Assistant), and a digital camera are applicable. Furthermore, a printer is exemplified as the communication apparatus 151 but the present disclosure is not limited to this, and various kinds of apparatuses are applicable as long as they can perform wireless communication with the information processing apparatus 101. For example, concerning a printer, an inkjet printer, a full-color laser beam printer, a monochrome printer, and the like are applicable. Furthermore, not only a printer but also a copying machine, a facsimile apparatus, a portable terminal, a smartphone, a laptop, a tablet terminal, a PDA, a digital camera, a music playback device, a television, a smart speaker, and the like are applicable. In addition, a multi-function peripheral having a plurality of functions such as a copying function, a FAX function, and a print function is applicable.

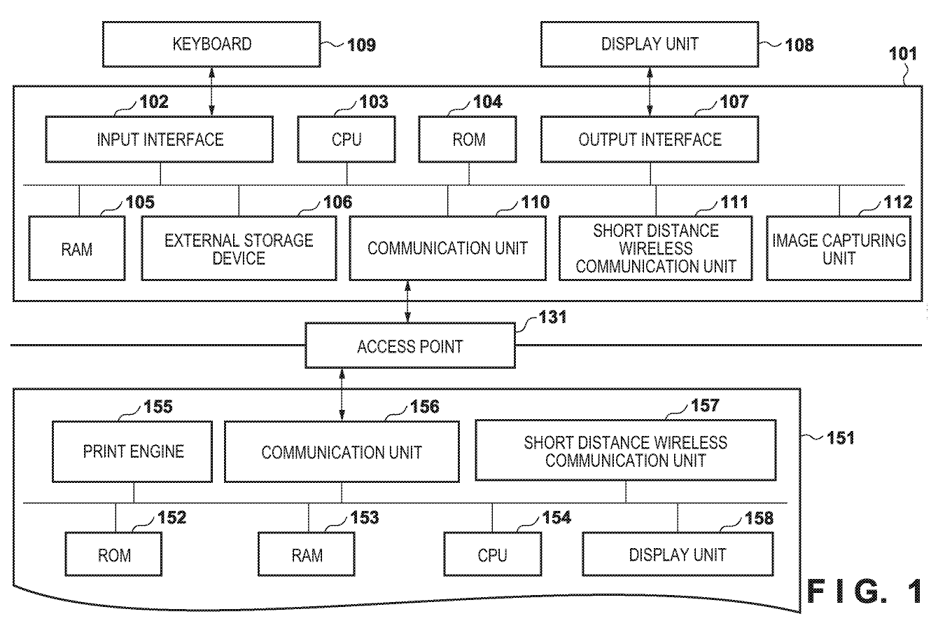

First, components of the information processing apparatus 101 of this embodiment and the communication apparatus 151 which can communicate with the information processing apparatus 101 of this embodiment will be described with reference to a block diagram shown in FIG. 1. Although this embodiment will exemplify the following components, the present disclosure is not limited to functions shown in FIG. 1. Apparatuses that are applicable to the information processing apparatus 101 and the communication apparatus 151 can appropriately include components corresponding to executable functions.

The information processing apparatus 101 includes an input interface 102, a CPU 103, a ROM 104, a RAM 105, an external storage device 106, an output interface 107, a display unit 108, a communication unit 110, a short distance wireless communication unit 111, and an image capturing unit 112. The CPU 103, the ROM 104, the RAM 105, and the like form a computer of the information processing apparatus 101 for executing a program.

The input interface 102 is an interface for accepting data input and instruction operations from the user when an operation unit such as a keyboard 109 is operated. Note that the operation unit may include a physical keyboard and physical buttons, or may include a software keyboard and software buttons displayed on the display unit 108. That is, the input interface 102 may accept input from the user via the display unit 108.

The CPU 103 is a system control unit and controls the whole information processing apparatus 101 such as execution of an application program. The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104.

The RAM 105 is formed by an SRAM (Static Random Access Memory) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and the work memory of the CPU 103.

The external storage device 106 stores an application program configured to execute a network setup of the communication apparatus 151, a printer management application, a print information generation program that generates print information interpretable by the printing apparatus 151, and the like. Each program is stored in the external storage device 106 by being installed from an external server (not shown) by, for example, Internet communication via the communication unit 110. A service registration application is an application program configured to transmit information acquired from the communication apparatus 151, personal information of the user acquired by the information processing apparatus 101, and the like to a service management server (not shown). The application program (setting application) configured to execute a network setup of the communication apparatus 151 is an application program configured to set an access point as the connection destination of the communication apparatus 151. The printer management application is an application configured to manage information of the printer. Note that the service registration application, the setting application, the printer management application, and the print information generation program (print application) may be formed as one application.

The output interface 107 is an interface configured to perform control for causing the display unit 108 to display data or make a notification concerning the state of the information processing apparatus 101. The display unit 108 is formed by an LED (Light-Emitting Diode), an LCD (Liquid Crystal Display), or the like and displays data or makes a notification concerning the state of the information processing apparatus 101. The image capturing unit 112 is, for example, a camera that captures the outside.

The communication unit 110 is a component connected to the apparatus such as the communication apparatus 151 or an access point 131 to execute data communication. For example, the communication unit 110 can be connected to an access point (not shown) in the communication apparatus 151. The communication unit 110 includes, as an access point in the information processing apparatus 101, an access point for connection to the apparatus such as the communication apparatus 151. This access point is generally called tethering. Note that a communication unit 156 of the communication apparatus 151 can be connected to the access point. When the communication unit 110 enables the access point, the information processing apparatus 101 operates as the access point. When the communication unit 156 and the access point in the communication unit 110 are connected, the information processing apparatus 101 and the communication apparatus 151 can communicate with each other. If the communication unit 110 of the information processing apparatus 101 is connected to the Internet, the communication apparatus 151 can also be connected to the Internet via the information processing apparatus 101. Note that in this embodiment, the information processing apparatus 101 can communicate with the communication apparatus 151 via an external apparatus existing outside the information processing apparatus 101 and the communication apparatus 151. Note that examples of the external apparatus include an external access point (the access point 131 or the like) existing outside the information processing apparatus 101 and the communication apparatus 151, and an apparatus, other than the access point, that can relay communication. For example, a device such as a wireless LAN router is used as the access point 131. The method of connecting the information processing apparatus 101 and the communication apparatus 151 via the external access point is called an infrastructure connection method.

The short distance wireless communication unit 111 is a component wirelessly connected to the apparatus such as the communication apparatus 151 in a short distance to execute data communication, and performs communication by a communication method different from that of the communication unit 110. The short distance wireless communication unit 111 can be connected to a short distance wireless communication unit 157 in the communication apparatus 151. As the communication method, for example, Near Field Communication (NFC), Bluetooth^{®} Classic, Bluetooth Low Energy (BLE), a Wi-Fi Aware, or the like is used.

The communication apparatus 151 includes a ROM 152, a RAM 153, a CPU 154, a print engine 155, the communication unit 156, the short distance wireless communication unit 157, and a display unit 158. The ROM 152, the RAM 153, the CPU 154, and the like form a computer of the communication apparatus 151 for executing a program.

The communication unit 156 includes, as the access point in the communication apparatus 151, an access point for connection to the external apparatus such as the information processing apparatus 101. Note that the access point can be connected to the communication unit 110 of the information processing apparatus 101. If the communication unit 156 enables the access point, the communication apparatus 151 operates as the access point. Note that the communication unit 156 may directly, wirelessly be connected to the information processing apparatus 101 or may wirelessly be connected to the information processing apparatus 101 via the access point 131. The wireless communication method used by the communication unit 156 is, for example, a communication standard based on the IEEE 802.11 series. The communication unit 156 may include a hardware component functioning as an access point or may operate as an access point by software for functioning as an access point.

A mode and a connection method of executing wireless communication using the communication unit 156 will now be described.

### Direct Connection Method

Direct connection indicates a form in which apparatuses are wirelessly connected directly (that is, by Peer to Peer) without intervention of an external apparatus such as the AP 131. Direct connection is also called Peer to Peer connection (P2P connection). As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE 802.11 communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, Go Negotiation in P2P. Note that in the WFD mode in a state before role making is performed, the communication apparatus 151 is neither the master station nor the slave station. More specifically, first, one of devices to communicate with each other issues a device search command and searches for a device to be connected in the WFD mode. After the other device serving as a communication partner is discovered, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the information processing apparatus 101) among devices (for example, the information processing apparatus 101 and the communication apparatus 151) to communicate with each other serves as a client that plays a role of requesting various services. The other device implements the function of an access point in Wi-Fi by software setting. The software AP corresponds to a Wi-Fi master station, and the client corresponds to a Wi-Fi slave station. In the software AP mode, the client searches for a device serving as a software AP by a device search command. After the software AP is discovered, the client and the software AP perform remaining wireless connection processing (establishment of wireless connection and the like) and IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station and can thus decide a specific frequency band and channel to be used for communication in the direct connection mode. In this embodiment, the communication apparatus 151 can use a channel corresponding to the 2.4-GHz frequency band and a channel corresponding to the 5-GHz frequency band for communication in the direct connection mode.

### Infrastructure Connection Method

Infrastructure connection is a connection form in which devices (for example, the information processing apparatus 101 and the communication apparatus 151) to communicate with each other are connected to an access point (for example, the AP 131) that controls a network of the devices, and the devices communicate with each other via the access point. As one connection mode, the communication apparatus 151 can operate in a mode (infrastructure connection mode) for communication by infrastructure connection.

In infrastructure connection, each device searches for an access point by a device search command. After an access point is discovered, the device and the access point perform remaining wireless connection processing (establishment of wireless connection and the like) and then IP connection processing (assignment of an IP address and the like). Note that commands and parameters transmitted/received when implementing wireless connection between the device and the access point suffice to be those defined by the Wi-Fi standard, and a description thereof will be omitted here.

In this embodiment, when the communication apparatus 151 operates in infrastructure connection, the AP 131 operates as a master station and the communication apparatus 151 operates as a slave unit. That is, in this embodiment, infrastructure connection means connection between the communication apparatus 151 operating as a slave unit and the apparatus operating as a master unit. In a case where the communication apparatus 151 establishes infrastructure connection and the information processing apparatus 101 also establishes infrastructure connection to the AP 131, the communication apparatus 151 and the information processing apparatus 101 can communicate with each other via the AP 131. Since the AP 131 decides a channel to be used for communication in infrastructure connection, the communication apparatus 151 executes communication in infrastructure connection using the channel decided by the AP 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the AP 131, the information processing apparatus 101 needs to recognize that the communication apparatus 151 belongs to a network which is formed by the AP 131 and to which the information processing apparatus 101 belongs.

### Network Setup Mode

The communication apparatus 151 can operate in the network setup mode. A trigger for the communication apparatus 151 to start an operation in the network setup mode may be, for example, the pressing of a network setup mode button by the user or activation (power-on) of the communication apparatus 151 for the first time after arrival. The network setup mode button may be a hardware (physical) button of the communication apparatus 151 or a software button displayed on the display unit 158 by the communication apparatus 151.

When the communication apparatus 151 starts an operation in the network setup mode, it enables Wi-Fi communication. More specifically, as Wi-Fi communication enabling processing, the communication apparatus 151 enables an internal AP (connection setting AP) of the communication apparatus 151 that is dedicated to the network setup mode. Then, the communication apparatus 151 can establish Wi-Fi direct connection to the information processing apparatus 101. Assume that connection information (SSID (Service Set Identifier) and password) for connection to the connection setting AP is held in advance in a setup application installed in the information processing apparatus 101, and the information processing apparatus 101 recognizes in advance the connection information for connection to the connection setting AP. Therefore, unlike connection information of an AP enabled in the direct connection mode, the connection information for connection to the connection setting AP cannot be changed arbitrarily by the user. Note that in the network setup mode, the communication apparatus 151 may be connected to the information processing apparatus 101 by not normal Wi-Fi but Wi-Fi Direct (WFD). That is, the communication apparatus 151 may operate as a group owner, and receive a setting command from the information processing apparatus 101 by WFD communication. Alternatively, the communication apparatus 151 may be connected to the information processing apparatus 101 by Bluetooth in the network setup mode. Bluetooth includes Bluetooth Classic and Bluetooth Low Energy (BLE). That is, for example, the communication apparatus 151 may operate as a slave apparatus in BLE in the network setup mode, and receive a setting command from the information processing apparatus 101 by BLE communication. Furthermore, in the network setup mode, the communication apparatus 151 may be able to execute both a network setup by Wi-Fi and a network setup by BLE. That is, when the communication apparatus 151 starts an operation in the network setup mode, it may enable both Wi-Fi communication and BLE communication. More specifically, when the communication apparatus 151 starts an operation in the network setup mode, it may enable both the connection setting AP and an advertising state in which BLE connection is enabled by transmitting advertising information by BLE.

When the communication apparatus 151 operates in the network setup mode, it controls the communication unit 156 to operate as a setup access point (connection setting AP) that is enabled only during an operation in the network setup mode. The setup access point is an access point different from that enabled in the above-described software AP mode. Assume that the SSID of the setup access point includes a predetermined character string recognizable by the setting application of the information processing apparatus 101.

Assume that the communication apparatus 151 operating in the network setup mode uses a predetermined communication protocol (setup communication protocol) in communication with the information processing apparatus 101 connected to the setup access point. More specifically, the setup communication protocol is, for example, SNMP (Simple Network Management Protocol).

If a predetermined time elapses after the communication apparatus 151 starts an operation in the network setup mode, the communication apparatus 151 stops the operation in the network setup mode and disables the setup access point. Furthermore, even when the connection information for connection to the AP 131 and a change instruction of the wireless communication operation mode are received from the information processing apparatus 101 in the network setup mode, the setup access point is disabled. Assume that the setup access point is an access point that does not require a password for connection. Note that the setup access point may be an access point that requires a password. In this case, a password used for connection to the setup access point is a fixed password (unchangeable by the user) that is grasped in advance by the setting application.

The communication unit 156 is assigned with a MAC address (Media Access Control Address). The MAC address is an identifier used to identify the communication unit, and is uniquely assigned to each communication unit in all the apparatuses including the communication apparatus and the information processing apparatus. Therefore, the MAC address is often used to identify the individual apparatus. In this embodiment, the identifier used to identify the apparatus will be referred to as apparatus identification information hereinafter. That is, the MAC address is an example of the apparatus identification information. In this embodiment, the MAC address is used as the apparatus identification information. However, the present disclosure is not limited to this. For example, a manufacturing number (serial number) assigned to the communication apparatus 151 may be used.

The short distance wireless communication unit 157 is a component wirelessly connected to the apparatus such as the information processing apparatus 101 in a short distance, and can be connected to, for example, the short distance wireless communication unit 111 in the information processing apparatus 101. As the communication method, for example, NFC, Bluetooth Classic, BLE, Wi-Fi Aware, or the like is used.

The RAM 153 is formed by an SRAM or the like, which needs a backup power supply. Note that the RAM 153 can store important data such as program control variables without volatilization because the data are held by a primary battery (not shown) for data backup. In addition, a memory area for storing setting information of the communication apparatus 151, management data of the communication apparatus 151, and the like is also provided in the RAM 153. Furthermore, the RAM 153 is used as the main memory and the work memory of the CPU 154 and a reception buffer to temporarily store print information received from the information processing apparatus 101 or the like or store various kinds of information.

The ROM 152 stores permanent data such as control programs to be executed by the CPU 154, data tables, and an OS program. In this embodiment, the control programs stored in the ROM 152 perform software execution control such as scheduling, task switch, and interrupt processing under the management of the embedded OS stored in the ROM 152. The ROM 152 also stores the serial number for identifying the communication apparatus 151. The serial number is uniquely assigned to identify the communication apparatus 151 by the manufacturer of the communication apparatus 151. In this embodiment, the serial number can also be used as the apparatus identification information that can be used to identify the communication apparatus 151. In a case where the communication apparatus 151 is a printer, the use status and remaining amount of ink are collected from the print engine 155 and stored in the ROM 152. The CPU 154 is a system control unit and controls the whole communication apparatus 151.

Based on information stored in the RAM 153 or a print job received from the information processing apparatus 101 or the like, the print engine 155 forms an image on a print medium such as a paper sheet by applying a printing material such as ink onto the print medium, and outputs the print result. Note that in general, the data amount of the print job transmitted from the information processing apparatus 101 or the like is large, and thus it is required to use, for communication of the print job, a communication method that allows high-speed communication. Therefore, the communication apparatus 151 receives the print job via the communication unit 156 that can perform communication at a speed higher than that of the short distance wireless communication unit 157. The display unit 158 is, for example, a panel, and displays data or makes a notification concerning the state of the communication apparatus 151.

Note that a memory such as an external HDD or an SD card may be attached as an optional device to the communication apparatus 151, and information stored in the communication apparatus 151 may be stored in the memory.

An arrangement is assumed in which the user selects a specific communication apparatus on the network from the information processing apparatus and operates the communication apparatus. The information processing apparatus stores network information such as the IP address and MAC address of the communication apparatus when communicating with the communication apparatus. Then, when performing subsequent connection to the specific communication apparatus in accordance with a user operation, connection to the stored IP address is performed. However, in a case where the IP address of the communication apparatus has been changed by DHCP (Dynamic Host Configuration Protocol), the information processing apparatus cannot discover the IP address, and cannot perform communication. In this case, the MAC address of the communication apparatus is acquired by broadcast communication, and is compared with the MAC address stored in the information processing apparatus, thereby specifying the communication apparatus.

On the other hand, since there is a security concern that the MAC address of the communication apparatus is observed by a third party to specify the user, a technique (to be referred to as MAC address randomization hereinafter) of periodically changing the MAC address is introduced to devices such as a smartphone. In a case where the MAC address of the communication apparatus has been randomized, it is impossible to specify the communication apparatus from the information processing apparatus by the above-described method.

To cope with this, in this embodiment, the MAC addresses of the communication apparatuses existing on the network are acquired by broadcast communication to extract the communication apparatus whose MAC address has been changed. The information processing apparatus receives an identifier other than the MAC address from the extracted communication apparatus, and compares the received identifier with the identifier stored in the information processing apparatus, thereby specifying the communication apparatus with which the information processing apparatus is to communicate. As described above, even in a case where the IP address or the MAC address stored in the information processing apparatus has been changed on the communication apparatus side, it is possible to specify the communication apparatus on the network.

Note that in this embodiment, as the communication apparatus 151, there exist an apparatus supporting a MAC address randomization function and an apparatus not supporting the MAC address randomization function. The MAC address randomization function is a function set by Institute of Electrical and Electronics Engineers (IEEE), and is a function of assigning, to an apparatus, a MAC address generated in accordance with the rule set by IEEE. A MAC address generated as a random value by the MAC address randomization function will be referred to as a random MAC address hereinafter. A MAC address of a fixed value that is not randomly generated by the MAC address randomization function and is not changed will be referred to as a fixed MAC address hereinafter. Then, the apparatus supporting the MAC address randomization function is an apparatus of a newer model (model number), and the apparatus not supporting the MAC address randomization function is an apparatus of an older model.

The apparatus supporting the MAC address randomization function can execute setting of whether to enable the MAC address randomization function. Then, the communication apparatus 151 which supports the MAC address randomization function and in which the MAC address randomization function is enabled provides a random MAC address to an external apparatus. That is, the random MAC address is used as the MAC address assigned to the communication unit 156 of the communication apparatus 151. Note that if the MAC address randomization function is enabled, the MAC address assigned to the communication unit 156 of the communication apparatus 151 is periodically changed. The changed MAC address is also generated as a random value by the MAC address randomization function. The communication apparatus 151 which supports the MAC address randomization function and in which the MAC address randomization function is not enabled provides a fixed MAC address. The communication apparatus 151 which does not support the MAC address randomization function also provides a fixed MAC address to an external apparatus. That is, the fixed MAC address is used as the MAC address assigned to the communication unit 156 of the communication apparatus 151.

Note that the MAC address assigned to the communication unit 156 of the communication apparatus 151 includes information indicating the random MAC address. The MAC address is represented by alphanumeric characters indicating 12 hexadecimal digits and a delimiter such as ":" (for example, 1A:2B:3C:4D:5E:6F). The two alphanumeric characters, divided by the delimiter, of the MAC address is called an octet. A MAC address in which the second bit is 1 when the value of the first octet (in the above example, 1A) is represented in binary is defined as a random MAC address by IEEE. Note that more specifically, the MAC address in which the second bit is 1 when the value of the first octet is represented in binary is, for example, a MAC address in which the value of the first octet ends with one of values of 2, 6, A, and E. Since the random MAC address is defined as described above, the fixed MAC address is a MAC address in which the value of the first octet ends with a value other than 2, 6, A, and E.

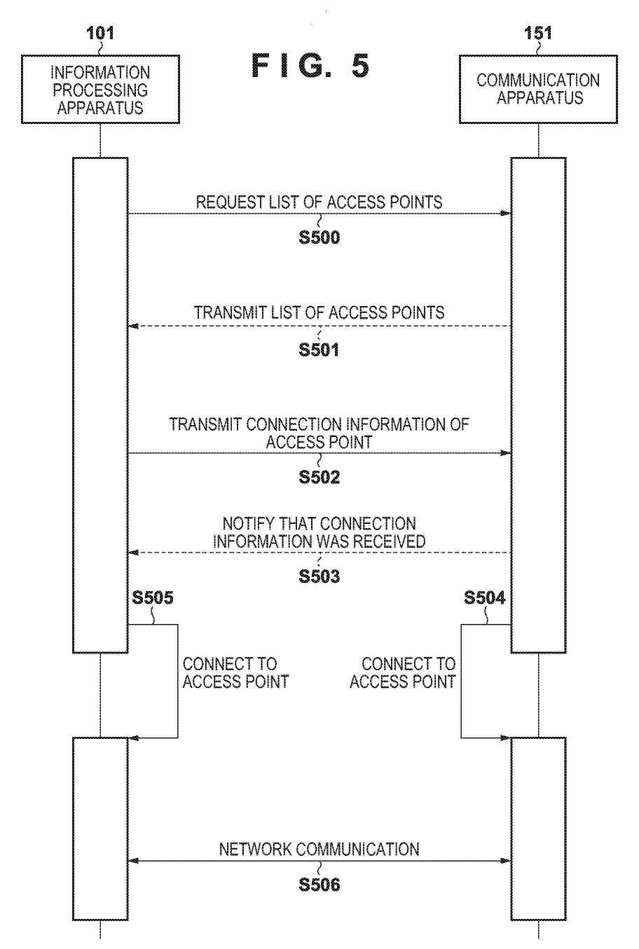

First, the network setup processing of the communication apparatus 151, which is executed by the information processing apparatus 101, will be described with reference to FIG. 5.

A sequence shown in FIG. 5 is implemented when, for example, the CPU of each apparatus reads out a program stored in the ROM, the external storage device, or the like of each apparatus to the RAM of each apparatus and executes the readout program. Note that as described above, the setup communication protocol is used in communication via Wi-Fi connection between the information processing apparatus 101 and the communication apparatus 151 operating in the network setup mode.

In S500, the information processing apparatus 101 requests, by the setting application, a list of access points from the communication apparatus 151 via the Wi-Fi connection between the information processing apparatus 101 and the communication apparatus 151 operating in the network setup mode.

Next, in S501, the communication apparatus 151 transmits the list of the access points to the information processing apparatus 101 via the Wi-Fi connection between the information processing apparatus 101 and the communication apparatus 151 operating in the network setup mode. Note that the transmitted list is a list indicating one or a plurality of access points which can be connected to the communication apparatus 151 and have been discovered by the communication apparatus 151 executing an AP search.

Next, in S502, the information processing apparatus 101 transmits, via the Wi-Fi connection between the information processing apparatus 101 and the communication apparatus 151 operating in the network setup mode, connection information of any of the access points included in the received list to the communication apparatus 151. Note that this processing is implemented when the setting application controls the information processing apparatus 101 to transmit connection information of any of the access points included in the received list. More specifically, in this processing, if the received list includes a connected AP, the information processing apparatus 101 transmits connection information of the connected AP. Alternatively, if the received list includes no connected AP, the information processing apparatus 101 displays the received list, and accepts, from the user, selection of any access point from the list. Then, the information processing apparatus 101 transmits connection information of the selected access point. Note that before transmitting the connection information, the information processing apparatus 101 accepts input of a password for connection to the access point from the user on a screen displayed by the print application. Then, the information processing apparatus 101 includes the accepted password in the connection information, and transmits the connection information.

In S503, the communication apparatus 151 notifies, via the Wi-Fi connection between the information processing apparatus 101 and the communication apparatus 151 operating in the network setup mode, the information processing apparatus 101 that the connection information has been received.

In S504, the communication apparatus 151 ends the network setup mode, and shifts to the infrastructure connection mode. Then, the communication apparatus 151 attempts connection to the access point corresponding to the connection information using the connection information acquired in S502. If connection succeeds, the communication apparatus 151 can execute communication via a network formed by the connected access point.

In S505, by the setting application, the information processing apparatus 101 performs, using the stored connection information, reconnection to the access point to which the information processing apparatus 101 was connected when a setting operation was performed. Note that the present disclosure is not limited to this form. For example, in a case where the information processing apparatus 101 transmits, to the communication apparatus 151, connection information of another access point different from the access point to which the information processing apparatus 101 was connected by Wi-Fi when a setting operation was performed, the information processing apparatus 101 may be connected to the other access point.

In S506, by the setting application, the information processing apparatus 101 searches for the communication apparatus 151 on the network to which the information processing apparatus 101 belongs. Then, in a case where the communication apparatus 151 is discovered, the information processing apparatus 101 requests capability information from the communication apparatus 151, and the communication apparatus 151 transmits the capability information to the information processing apparatus 101. Thus, the information of the communication apparatus 151 is registered in the setting application, and after that, it is possible to execute communication with the communication apparatus 151 by the setting application or another application. More specifically, for example, it is possible to transmit a print job to the communication apparatus 151 by the print application. Note that the registered information includes, for example, an IP address, a MAC address, and a serial number. Note also that the MAC address at this time is a MAC address that is not randomized. In a case where the information processing apparatus 101 belongs to the network formed by the access point to which the communication apparatus 151 is connected by the network setup, it is possible to execute communication with the communication apparatus 151 via the access point. Note that communication at this time is executed using, for example, a communication protocol different from the setup communication protocol.

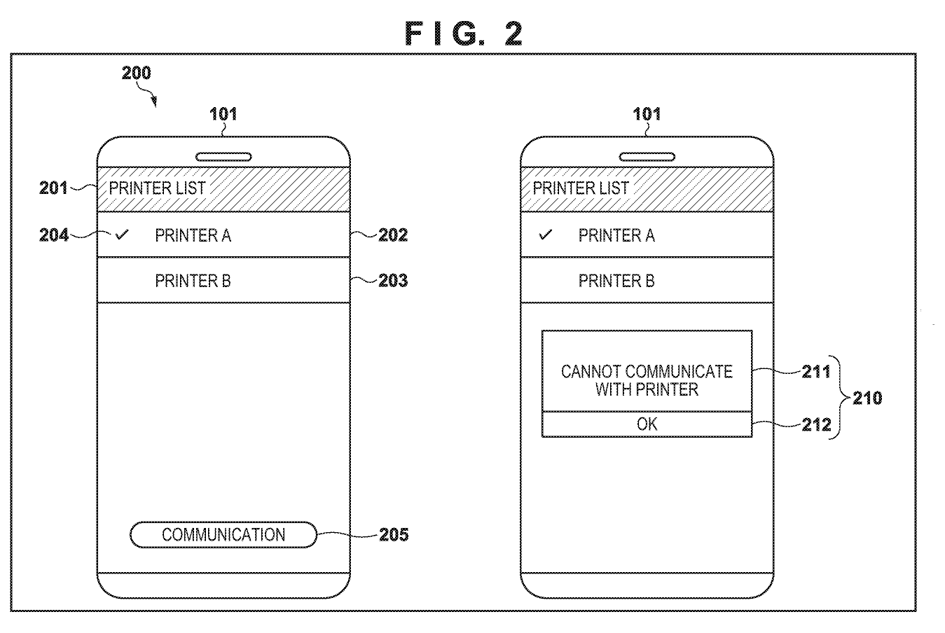

FIG. 2 is a view showing an example of a printer list screen 200 displayed by the setting application of the information processing apparatus 101. The printer list screen 200 displays a list of communication apparatuses 151 to which the information processing apparatus 101 has been connected via the communication unit 110 in the past. That is, as described above, the pieces of information of the communication apparatuses 151 are registered in the setting application. In a title 201, the title of the screen is displayed. In printer information display areas 202 and 203, the names of the communication apparatuses 151 are displayed, respectively. Each of the printer information display areas 202 and 203 can accept a selection operation from the user, and a check mark 204 is displayed in a portion where the selection operation has been accepted. For example, FIG. 2 shows a state in which the communication apparatus 151 (printer A) displayed in the printer information display area 202 is currently selected.

When a communication button 205 is pressed, the information processing apparatus 101 communicates with the communication apparatus 151 corresponding to the selected printer information display area. At this time, the information processing apparatus 101 performs connection to the stored IP address. If communication succeeds, the check mark is deleted from the printer information display area 202, and for example, a screen for executing a job is displayed. On the other hand, if communication fails, a printer connection error dialog 210 is displayed. The printer connection error dialog 210 displays a message 211 indicating that it is impossible to communicate with the printer. When an error dialog confirmation button 212 is pressed, control returns to display of the printer list screen 200. At this time, the printer information display area corresponding to the printer with which communication has failed may be displayed to be unselectable.

An example of a case where communication with the selected communication apparatus 151 fails is a case where the IP address of the communication apparatus has been changed by DHCP. In this case, since the information processing apparatus 101 cannot discover the IP address, communication fails.

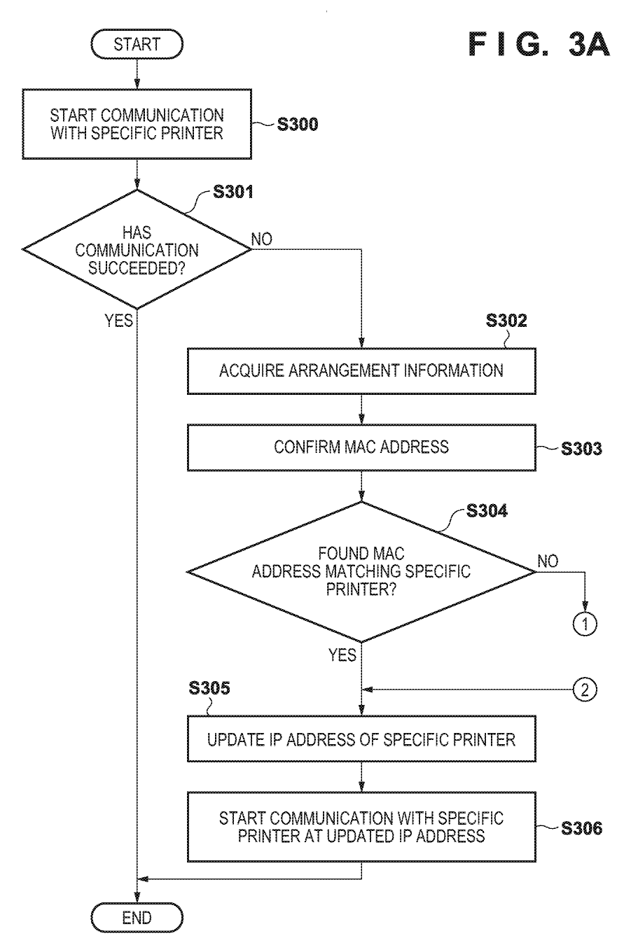

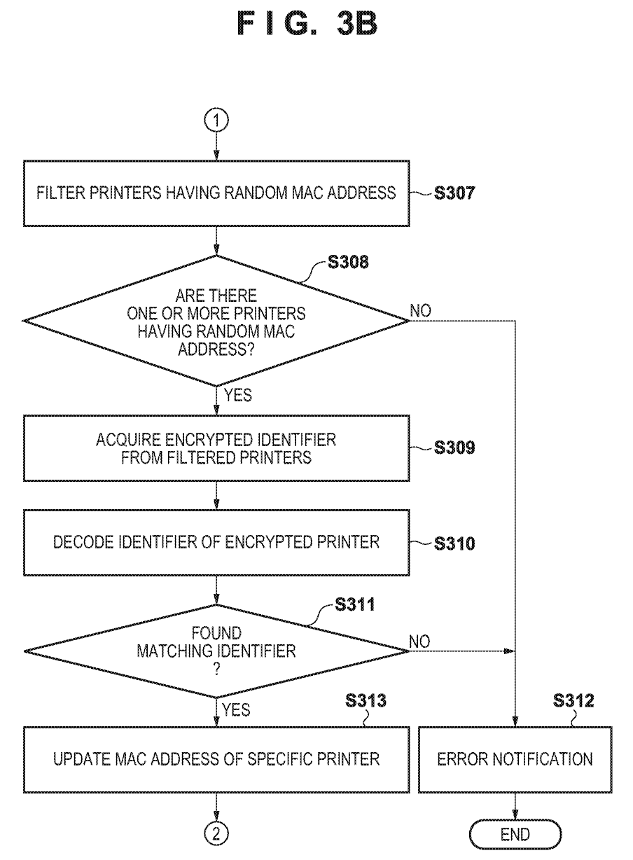

Processing of specifying the communication apparatus 151 (communication target) with which communication is desired and which is selected by the user will be described below with reference to FIGS. 3A and 3B.

FIGS. 3A and 3B are flowcharts illustrating processing executed by the information processing apparatus 101. The processing shown in FIGS. 3A and 3B is implemented when, for example, the CPU 103 of the information processing apparatus 101 reads out a program stored in the ROM 104 to the RAM 105 and executes the readout program. The processing shown in FIGS. 3A and 3B is started when, for example, the printer information display area 202 is selected in the printer list screen 200 shown in FIG. 2 and an instruction to start communication is accepted.

In step S300, the CPU 103 starts communication processing with the communication apparatus 151 using the IP address stored in the information processing apparatus 101. For example, the CPU 103 starts communication processing with the communication apparatus 151 using the IP address registered in association with the selected printer information display area 202. The communication apparatus 151 corresponding to the selected printer information display area 202 will be referred to as printer A hereinafter. The IP address and the MAC address registered in association with the communication apparatus 151 will be referred to as IP address A and MAC address A, respectively, hereinafter.

In step S301, the CPU 103 determines whether communication with printer A has succeeded. For example, in a case where connection to printer A has been performed using IP address A, it is determined that communication has succeeded. If it is determined that communication has succeeded, the processing shown in FIGS. 3A and 3B ends, and for example, a screen for performing processing such as job execution processing for printer A is displayed. On the other hand, if it is determined that communication has failed, the process advances to step S302.

In step S302, the CPU 103 acquires the arrangement information of the communication apparatus 151 existing on the network. The arrangement information is information including the MAC address, the printer name, and the IP address. Furthermore, for example, the CPU 103 acquires the pieces of arrangement information of the plurality of communication apparatuses 151 existing on the network by broadcast communication via the communication unit 110. With the processing in step S302, a list of the MAC addresses of the communication apparatuses 151 existing on the network is acquired.

In step S303, the CPU 103 compares MAC address A of printer A with the list of the MAC addresses acquired in step S302. Then, in step S304, the CPU 103 determines whether the list of the MAC addresses includes a MAC address matching MAC address A. If it is determined that the matching MAC address is included, the process advances to step S305.

In step S305, the CPU 103 acquires an IP address corresponding to the MAC address matching MAC address A. In this example, the IP address will be referred to as IP address A' hereinafter. The CPU 103 updates, to IP address A', IP address A corresponding to MAC address A stored in the information processing apparatus 101. Then, in step S306, the CPU 103 starts communication processing with printer A using updated IP address A'. After step S306, the processing shown in FIGS. 3A and 3B ends, and for example, a screen for performing processing such as job execution processing for printer A is displayed.

As described above, even if the IP address of printer A is changed by DHCP, it is possible to acquire the changed IP address and perform communication based on the MAC address stored in the information processing apparatus 101 and the list of the MAC addresses acquired from the network.

On the other hand, if it is determined that the list of the MAC addresses includes no MAC address matching MAC address A, the process advances to step S307.

In step S307, the CPU 103 extracts a random MAC address from the list of the MAC addresses (filtering). For example, the CPU 103 extracts the random MAC address based on the above-described information indicating the random MAC address. In step S308, the CPU 103 determines whether there exists at least one random MAC address. If it is determined that the list of the MAC addresses includes no random MAC address, the process advances to step S312.

A case where the process advances to step S312 is, for example, a case where printer A with which communication is desired is not powered on. In step S312, the CPU 103 displays the printer connection error dialog 210, and then ends the processing shown in FIGS. 3A and 3B.

If it is determined in step S308 that there exists at least one random MAC address, the process advances to step S309. In step S309, the CPU 103 acquires the identifier of the communication apparatus 151, which is different from the MAC address, from the communication apparatus 151 corresponding to each extracted random MAC address. The acquired identifier is information that can be used to identify the communication apparatus 151, and is, for example, the serial number of the communication apparatus 151. Note that the ROM 104 of the information processing apparatus 101 stores a serial number corresponding to printer A registered in the setting application. In this example, the serial number will be referred to as serial number A hereinafter. In step S309, the serial number of the communication apparatus 151 is acquired by encrypted communication. Encrypted communication may be performed by, for example, SSL (TLS) communication, and a common key usable between the information processing apparatus 101 and the communication apparatus 151 is generated using a server certificate and a public key between these apparatuses, thereby implementing encrypted communication by the common key. In addition, generation of a common key used for encrypted communication and the like may be performed at the time of, for example, registration in the setting application.

In step S310, the CPU 103 decodes the encrypted information acquired in step S309 from the communication apparatus 151 corresponding to each extracted random MAC address, thereby acquiring the serial number of each communication apparatus 151. Note that this embodiment has explained that the serial number is acquired by encrypted communication but the serial number may be acquired without being encrypted. For example, the serial number may be acquired as one piece of arrangement information in step S302.

In step S311, the CPU 103 determines whether the serial numbers acquired in step S310 include a serial number matching serial number A stored in the information processing apparatus 101. If it is determined that the matching serial number is included, the CPU 103 acquires, in step S313, the random MAC address corresponding to the serial number and the IP address corresponding to the random MAC address based on the serial number matching serial number A. In this example, the acquired random MAC address and IP address will be referred to as random MAC address A and IP address A', respectively, hereinafter. Then, the CPU 103 updates MAC address A stored in the information processing apparatus 101 to random MAC address A. After step S313, in step S305, the CPU 103 updates, to IP address A', IP address A stored in the information processing apparatus 101 and corresponding to random MAC address A. Subsequently, the processing in step S306 is performed.

As described above, even if the IP address of printer A is changed by DHCP and the MAC address is randomized, it is possible to specify, on the network, the communication apparatus 151 with which communication is desired and to perform communication.

If it is determined in step S311 that there is no serial number matching serial number A stored in the information processing apparatus 101, the process advances to step S312. A case where the process advances to step S312 is, for example, a case where printer A with which communication is desired is not powered on. In step S312, the CPU 103 displays the printer connection error dialog 210, and then ends the processing shown in FIGS. 3A and 3B.

As described above, according to this embodiment, even if the IP address is changed by DHCP and the MAC address is randomized, it is possible to specify, on the network, the communication apparatus 151 with which communication is desired and to perform communication.

This embodiment has explained that the serial number is acquired by encrypted communication in step S309. However, any method other than encrypted communication may be used as long as communication intended to prevent identification of individuals is performed. For example, a hash value calculated based on the serial number in the communication apparatus 151 corresponding to each extracted random MAC address may be acquired. On the other hand, the CPU 103 calculates hash value A based on serial number A stored in the information processing apparatus 101. It is determined whether the hash values acquired from the network include a hash value matching hash value A. If it is determined that the matching hash value is included, the random MAC address and IP address corresponding to the hash value are the random MAC address and IP address of printer A with which communication is desired. Then, the CPU 103 updates, in step S313, MAC address A stored in the information processing apparatus 101 to random MAC address A, and updates, in step S305, to IP address A', IP address A stored in the information processing apparatus 101 and corresponding to random MAC address A. On the other hand, if it is determined that the matching hash value is not included, the CPU 103 displays the printer connection error dialog 210 in step S312.

### Second Embodiment

The second embodiment will be described below concerning points different from the first embodiment. In this embodiment, in accordance with the model of a communication apparatus 151 with which communication is desired, a method of specifying a communication apparatus with which communication is desired is switched. That is, if the model of the communication apparatus 151 with which communication is desired is a model having no identifier other than a MAC address, a MAC address before randomization by a randomization function is acquired from the communication apparatus 151 corresponding to a random MAC address. The MAC address before randomization, which is held in the apparatus when the MAC address is randomized by the randomization function, will specifically be referred to as an "original MAC address" hereinafter. In other words, the MAC address before randomization by the MAC address randomization function is a MAC address that is not randomized by the MAC address randomization function.

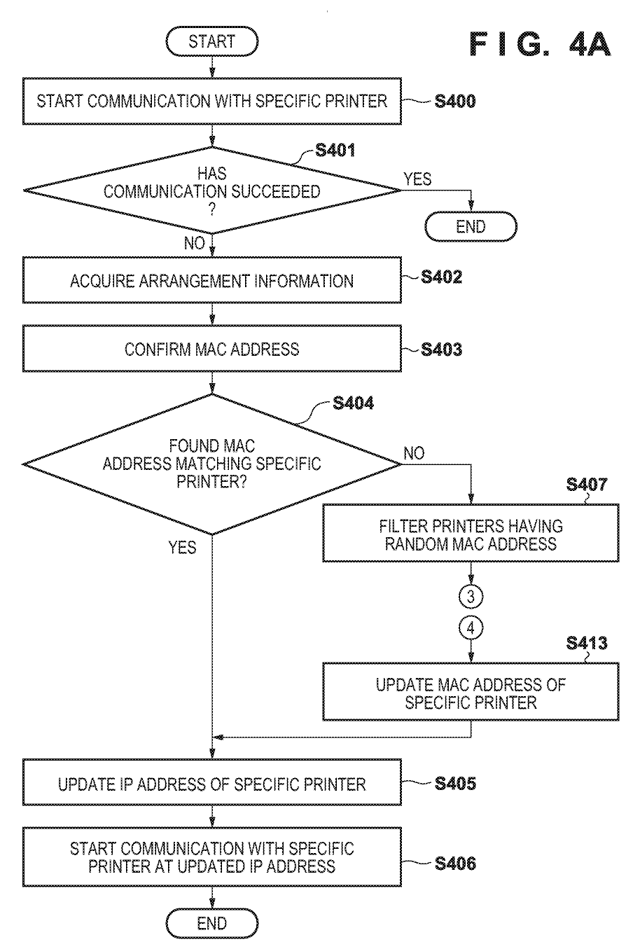

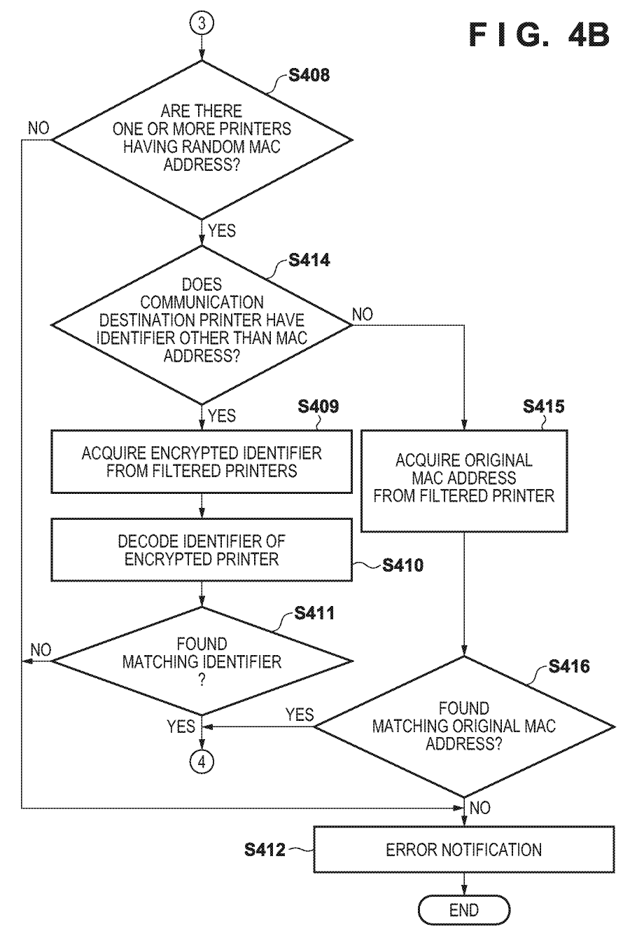

FIGS. 4A and 4B are flowcharts illustrating processing executed by an information processing apparatus 101. The processing shown in FIGS. 4A and 4B is implemented when, for example, a CPU 103 of the information processing apparatus 101 reads out a program stored in a ROM 104 to a RAM 105 and executes the readout program. The processing shown in FIGS. 4A and 4B is started when, for example, a printer information display area 202 is selected in a printer list screen 200 shown in FIG. 2 and an instruction to start communication is accepted.

Steps S400 to S413 are the same as steps S300 to S313 of FIGS. 3A and 3B and a description thereof will be omitted. If it is determined in step S408 that a list of MAC addresses includes at least one random MAC address, the process advances to step S414.

In step S414, the CPU 103 determines whether the communication apparatus 151 selected in the printer list screen 200 is an apparatus having an identifier (to be referred to as the second identifier hereinafter) for uniquely identifying the communication apparatus 151 other than the MAC address. In this embodiment, the second identifier is, for example, a serial number. For example, model information (a model name or the like) registered in a setting application indicates an inkjet printer, it is determined that the communication apparatus 151 has the second identifier. For example, if the model information (the model name or the like) indicates a laser beam printer, it is determined that the communication apparatus 151 has no second identifier. If it is determined in step S414 that the communication apparatus 151 is an apparatus having the second identifier, processes in steps S409 to S411, S413, S405, and S406 are executed. That is, the communication apparatus 151 with which communication is desired is specified by the serial number.

On the other hand, if it is determined in step S414 that the communication apparatus 151 is an apparatus having no second identifier, the CPU 103 acquires, in step S415, the original MAC address from the communication apparatus 151 extracted in step S407. In this embodiment, an OID (Object Identifier) that stores the original MAC address is provided in a MIB (Management Information Base) in the communication apparatus 151. The MIB formed here may be a standard MIB such as a printer MIB or a private MIB originally defined by the vendor. In step S415, for example, the CPU 103 designates, using Get-Request as a MIB acquisition command, the location where the original MAC address is stored, thereby acquiring the original MAC address. With the processing in step S415, a list of the original MAC addresses of the communication apparatuses 151 existing on the network is acquired.

In step S416, the CPU 103 compares MAC address A of printer A with the list of the original MAC addresses acquired in step S415. Then, the CPU 103 determines whether the list of the original MAC addresses includes a MAC address matching MAC address A stored in the information processing apparatus 101. If it is determined that the matching MAC address is included, the process advances to step S413. On the other hand, if it is determined that no matching MAC address is included, the process advances to step S412.

As described above, according to this embodiment, it is possible to acquire the original MAC address from the communication apparatus having no second identifier other than the MAC address, specify the communication apparatus 151 with which communication is desired, and perform communication.

According to the present disclosure, even if identification information of a communication apparatus is randomized, it is possible to specify a desired communication apparatus from a plurality of communication apparatuses.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus comprising at least one memory and at least one processor which function as:
a first acquisition unit configured to acquire first identification information as a MAC address from a communication apparatus;
a second acquisition unit configured to acquire, based on a fact that the acquired first identification information is a MAC address that is randomized in the communication apparatus by a predetermined function of randomizing a MAC address of the communication apparatus, second identification information as a predetermined kind of identification information different from a MAC address from the communication apparatus that has transmitted the first identification information to the information processing apparatus; and
a first execution unit configured to execute, using the acquired second identification information, processing for communicating with the communication apparatus that has transmitted the first identification information to the information processing apparatus.

2. The information processing apparatus according to claim 1, wherein
the at least one memory and the at least one processor further function as
a first storage unit configured to store the MAC address acquired from the communication apparatus in the information processing apparatus, and
wherein the second identification information is acquired based on a fact that the MAC address stored in the information processing apparatus does not match the acquired first identification information and the acquired first identification information is the MAC address that is randomized in the communication apparatus by the predetermined function.

3. The information processing apparatus according to claim 2, wherein
the at least one memory and the at least one processor further function as
a transmission unit configured to transmit, to the communication apparatus, connection information for connection to an access point,
a search unit configured to search for the communication apparatus on a network to which the information processing apparatus belongs, after the connection information is transmitted to the communication apparatus, and
an information acquisition unit configured to acquire identification information from the communication apparatus discovered on the network to which the information processing apparatus belongs, and
wherein a MAC address included in the identification information acquired from the communication apparatus discovered on the network to which the information processing apparatus belongs is stored in the information processing apparatus.

4. The information processing apparatus according to claim 2, wherein
MAC addresses are acquired from a plurality of communication apparatuses on a network by broadcast communication,
the first identification information is information included in the plurality of MAC addresses acquired from the plurality of communication apparatuses by the broadcast communication, and
the second identification information is acquired based on a fact that the MAC address stored in the information processing apparatus does not match any of the plurality of MAC addresses and the acquired first identification information is the MAC address that is randomized in the communication apparatus by the predetermined function.

5. The information processing apparatus according to claim 4, wherein
the at least one memory and the at least one processor further function as
a notification unit configured to execute an error notification in a case where the plurality of MAC addresses acquired from the plurality of communication apparatuses by the broadcast communication include no MAC address that is randomized in the communication apparatus by the predetermined function.

6. The information processing apparatus according to claim 4, wherein
the at least one memory and the at least one processor further function as
a second storage unit configured to store, in the information processing apparatus, a specific kind of identification information different from a MAC address and different from the predetermined kind of identification information, which is acquired from the communication apparatus, and
a start unit configured to start communication with the communication apparatus using the specific kind of identification information, and
wherein in a case where communication with the communication apparatus using the specific kind of identification information fails, the MAC addresses are acquired from the plurality of communication apparatuses by the broadcast communication.

7. The information processing apparatus according to claim 6, wherein the specific kind of identification information is an IP address.

8. The information processing apparatus according to claim 6, wherein
the at least one memory and the at least one processor further function as
a transmission unit configured to transmit, to the communication apparatus, connection information for connection to an access point,
a search unit configured to search for the communication apparatus on a network to which the information processing apparatus belongs, after the connection information is transmitted to the communication apparatus, and
an information acquisition unit configured to acquire identification information from the communication apparatus discovered on the network to which the information processing apparatus belongs, and
wherein the specific kind of identification information included in the identification information acquired from the communication apparatus discovered on the network to which the information processing apparatus belongs is stored in the information processing apparatus.

9. The information processing apparatus according to claim 6, wherein
the processing for communicating with the communication apparatus that has transmitted the first identification information to the information processing apparatus is processing of newly acquiring the specific kind of identification information from the communication apparatus that has transmitted the first identification information to the information processing apparatus, and
communication with the communication apparatus is executed using the newly acquired specific kind of identification information.

10. The information processing apparatus according to claim 2, wherein
the at least one memory and the at least one processor further function as
a third acquisition unit configured to acquire, in a case where the MAC address stored in the information processing apparatus does not match the acquired first identification information and the communication apparatus that has transmitted the MAC address stored in the information processing apparatus to the information processing apparatus is an apparatus having no predetermined kind of identification information, third identification information as a MAC address, that is not randomized in the communication apparatus by the predetermined function, from the communication apparatus that has transmitted the first identification information to the information processing apparatus, and
a second execution unit configured to execute, using the acquired third identification information, the processing for communicating with the communication apparatus that has transmitted the first identification information to the information processing apparatus, and
wherein in a case where the MAC address stored in the information processing apparatus does not match the acquired first identification information and the communication apparatus that has transmitted the MAC address stored in the information processing apparatus to the information processing apparatus is an apparatus having the predetermined kind of identification information, the second identification information is acquired.

11. The information processing apparatus according to claim 10, wherein
a case where the communication apparatus that has transmitted the MAC address stored in the information processing apparatus to the information processing apparatus is an apparatus having no predetermined kind of identification information is a case where information indicating a model of the apparatus that has transmitted the MAC address stored in the information processing apparatus to the information processing apparatus is information indicating a laser beam printer, and
a case where the communication apparatus that has transmitted the MAC address stored in the information processing apparatus to the information processing apparatus is an apparatus having the predetermined kind of identification information is a case where information indicating a model of the apparatus that has transmitted the MAC address stored in the information processing apparatus to the information processing apparatus is information indicating an inkjet printer.

12. The information processing apparatus according to claim 1, wherein
the at least one memory and the at least one processor further function as
a third storage unit configured to store, in the information processing apparatus, the predetermined kind of identification information acquired from the communication apparatus, and
wherein based on a fact that the predetermined kind of identification information stored in the information processing apparatus matches the acquired second identification information, the processing for communicating with the communication apparatus that has transmitted the first identification information to the information processing apparatus is executed using the acquired second identification information.

13. The information processing apparatus according to claim 12, wherein
the at least one memory and the at least one processor further function as
a transmission unit configured to transmit, to the communication apparatus, connection information for connection to an access point,
a search unit configured to search for the communication apparatus on a network to which the information processing apparatus belongs, after the connection information is transmitted to the communication apparatus, and
an information acquisition unit configured to acquire identification information from the communication apparatus discovered on the network to which the information processing apparatus belongs, and
wherein the predetermined kind of identification information included in the identification information acquired from the communication apparatus discovered on the network to which the information processing apparatus belongs is stored in the information processing apparatus.

14. The information processing apparatus according to claim 1, wherein the second identification information is acquired from the communication apparatus by encrypted communication.

15. The information processing apparatus according to claim 14, wherein
the at least one memory and the at least one processor further function as
a transmission unit configured to transmit, to the communication apparatus, connection information for connection to an access point,
a search unit configured to search for the communication apparatus on a network to which the information processing apparatus belongs, after the connection information is transmitted to the communication apparatus,
an information acquisition unit configured to acquire identification information from the communication apparatus discovered on the network to which the information processing apparatus belongs, and
a registration unit configured to register the communication apparatus in an application program of the information processing apparatus based on the identification information acquired from the communication apparatus discovered on the network to which the information processing apparatus belongs, and
wherein generation of a common key used by the encrypted communication is executed in a case where the communication apparatus is registered in the application program of the information processing apparatus.

16. The information processing apparatus according to claim 1, wherein
the at least one memory and the at least one processor further function as
a job transmission unit configured to transmit a print job for executing printing to the communication apparatus that has transmitted the first identification information to the information processing apparatus.

17. The information processing apparatus according to claim 1, wherein the second identification information is a serial number.

18. The information processing apparatus according to claim 1, wherein the predetermined function is a function of assigning, to an apparatus, a MAC address generated in accordance with a rule set by Institute of Electrical and Electronics Engineers (IEEE).

19. A control method for an information processing apparatus, comprising:
acquiring first identification information as a MAC address from a communication apparatus;
acquiring, based on a fact that the acquired first identification information is a MAC address that is randomized in the communication apparatus by a predetermined function of randomizing a MAC address of the communication apparatus, second identification information as a predetermined kind of identification information different from a MAC address from the communication apparatus that has transmitted the first identification information to the information processing apparatus; and
executing, using the acquired second identification information, processing for communicating with the communication apparatus that has transmitted the first identification information to the information processing apparatus.

20. A non-transitory computer-readable storage medium storing a program configured to cause a computer of an information processing apparatus to function to:
acquire first identification information as a MAC address from a communication apparatus;
acquire, based on a fact that the acquired first identification information is a MAC address that is randomized in the communication apparatus by a predetermined function of randomizing a MAC address of the communication apparatus, second identification information as a predetermined kind of identification information different from a MAC address from the communication apparatus that has transmitted the first identification information to the information processing apparatus; and
execute, using the acquired second identification information, processing for communicating with the communication apparatus that has transmitted the first identification information to the information processing apparatus.
